(19) United States
(12) Patent Application Publication
(10) Pub. No.: US 2017/0277447 A1
(43) Pub. Date: Sep. 28, 2017

(54) Active Storage Devices

(71) Applicant: Agency For Science, Technology And Research, Singapore (SG)

(72) Inventors: Weiya XI, Singapore (SG); Chao JIN, Singapore (SG); Khai Leong YONG, Singapore (SG); Pantelis ALEXOPOULOS, Singapore (SG)

(21) Appl. No.: 15/508,866

(22) PCT Filed: Sep. 28, 2015
(86) PCT No.: PCT/SG2015/050348

§ 371 Date: Mar. 3, 2017

(30) Foreign Application Priority Data
Oct. 3, 2014 (SG) 10201406338X

(51) Int. Cl. G06F 3/06; G06F 12/0811

(52) U.S. Cl. CPC G06F 3/0613; G06F 3/0611; G06F 12/0811; G06F 2212/62

(57) ABSTRACT

A printed circuit board assembly (PCBA) for a storage device comprising a non-volatile memory (NVM) and a multi-core processor, wherein a first core of the multi-core processor is devoted to external interface management and a second core of the multi-core processor is devoted to internal data management.

### FIELD OF THE INVENTION

The present invention relates to the field of storage devices, such as Hard Disk Drives (HDDs) and Solid State Drives (SSDs). In particular, it relates to intelligent printed circuit board assemblies (PCBAs) for active storage devices.

### BACKGROUND

Storage devices generally refer to hardware capable of holding data information. One example of a storage device is a Hard Disk Drive (HDD), which conventionally comprises disk media, an actuator for reading or writing data to the disk media, and a printed circuit board assembly (PCBA) which controls the read/write operations of the actuator. Another example of a storage device is a Solid State Drive (SSD) which comprises Non Volatile Memory (NVM) in electrical communication with a PCBA in the SSD. Recent developments in the field of storage devices has integrated Non Volatile Memory (NVM) into HDDs, resulting in hybrid drives having both disk media and NVM in electrical communication with the PCBA of the HDD.

A disk array controller is needed to connect a plurality of HDDs, SSDs, and/or hybrid drives. The controller is typically a Redundant Array of Independent Disks (RAID) controller, which distributes data across the drives in accordance with predetermined RAID configurations. However, when a large number of storage drives are to be networked, multiple RAID controllers are required. This translates to additional costs required for maintaining and expanding a network of storage drives. Moreover, the dependency on RAID controllers severely limits parallel data access to individual drives in the network, therefore restricting the data throughput in the network.

Accordingly, what is needed is a storage device that is able to perform independently from a disk array controller to facilitate data storage and data management in a storage network. Furthermore, other desirable features and characteristics will become apparent from the subsequent detailed description and the appended claims, taken in conjunction with the accompanying drawings and this background of the disclosure.

### SUMMARY OF THE INVENTION

In accordance with a first aspect of the present invention, a printed circuit board assembly (PCBA) for a storage device is disclosed, the PCBA comprising: a non-volatile memory (NVM); and a multi-core processor; wherein a first core of the multi-core processor is devoted to external interface management; and wherein a second core of the multi-core processor is devoted to internal data management.

In accordance with a second aspect of the present invention, a hard disk drive (HDD) is disclosed, the HDD comprising: disk media; and a printed circuit board assembly (PCBA) coupled to the disk media for external interface management and internal data management, the PCBA comprising: a non-volatile memory (NVM); and a multi-core processor, wherein a first core of the multi-core processor is devoted to the external interface management, and wherein a second core of the multi-core processor is devoted to the internal data management, and wherein the NVM is used with the disk media of the HDD for hybrid data storage.

In accordance with a third aspect of the present invention, a Solid State Drive (SSD) is disclosed, the SSD comprising a a printed circuit board assembly (PCBA), the PCBA comprising: a non-volatile memory (NVM); and a multi-core processor, wherein a first core of the multi-core processor is devoted to external interface management and a second core of the multi-core processor is devoted to internal data management.

In accordance with a fourth aspect of the present invention, a HDD for data storage is disclosed, the HDD for data storage comprising: one or more disk platters, each of the one or more disk platters having magnetic disk media on one or both sides; an axial motor for rotating the one or more disk platters; one or more actuators for reading data to and writing data from the one or more disk platters; one or more interfaces coupled to the one or more actuators; and a printed circuit board assembly (PCBA) coupled to the axial motor, the one or more actuators, and the one or more interfaces, wherein the PCBA comprises: a non-volatile memory (NVM); and a multi-core processor, wherein a first core of the multi-core processor is devoted to external interface management and a second core of the multi-core processor is devoted to internal data management.

In accordance with a fifth aspect of the present invention, a system for distributed data storage is disclosed, the system comprising: one or more storage devices, the one or more storage devices comprising a printed circuit board assembly (PCBA), the PCBA comprising: a non-volatile memory (NVM); and a multi-core processor, wherein a first core of the multi-core processor is devoted to external interface management and a second core of the multi-core processor is devoted to internal data management of the corresponding one of the one or more storage devices; and one or more client terminals, wherein the one or more storage devices and the one or more client terminals are coupled to a network and configured to perform a distributed data storage operation within the one or more storage devices in response to a request by any one of the one or more client terminals, the distributed data storage operation performed in cooperation with the first core's external interface management.

### BRIEF DESCRIPTION OF DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1, comprising FIG. 1A and FIG. 1B, illustrates top perspective drawings of storage devices, in accordance with a present embodiment, wherein FIG. 1A illustrates a Hard Disk Drive (HDD) and FIG. 1B illustrates a Solid State Drive (SSD), both the HDD and SSD having an intelligent Printed Circuit Board Assembly (PCBA).

FIG. 2, comprising FIG. 2A, FIG. 2B, and FIG. 2C, illustrates components of HDDs with an intelligent PCBA, in accordance with the present embodiment, wherein FIG. 2A illustrates a top cutaway perspective drawing of a dual actuator HDD, FIG. 2B illustrates a side cross-sectional perspective drawing of disk media and dual actuators within the dual actuator HDD, and FIG. 2C illustrates a bottom cutaway perspective of a HDD.

FIG. 3 depicts a block diagram of an Active Drive (AD) with an intelligent PCBA in accordance with the present embodiment.

FIG. 4 depicts a diagram illustrating functions of the AD in accordance with the present embodiment.

FIG. 5 depicts a diagram illustrating functions performed by one or more cores of the intelligent PCBA of an AD in accordance with the present embodiment.

And FIG. 6, comprising FIG. 6A, FIG. 6B, and FIG. 6C, depict a diagram of an exemplary system of one or more storage devices in a network, in accordance with the present embodiment, wherein FIG. 6A depicts a system of one or more conventional storage devices in communication with a client and a metadata server through a network, FIG. 6B depicts one or more storage devices (i.e. active drives) in communication with a client and a metadata server through a network, and FIG. 6C depicts an exemplary operation performed in the system.

Skilled artisans will appreciate that elements in the figures are illustrated for simplicity and clarity and have not necessarily been depicted to scale. For example, the dimensions of some of the elements in the block diagrams or flowcharts may be exaggerated in respect to other elements to help to improve understanding of the present embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiment to present an improved storage device that is able to perform independently from a disk array controller to facilitate data storage and data management in a storage network.

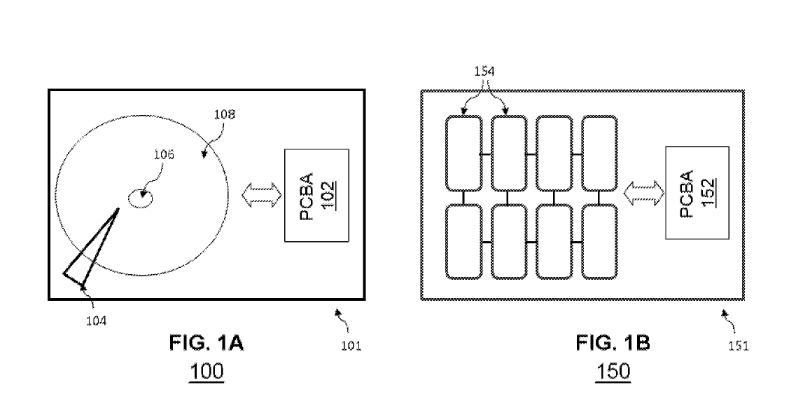

FIG. 1, comprising FIG. 1A (the top planar view 100) and FIG. 1B (the top planar view 150), illustrates storage devices 101, 151, wherein FIG. 1A illustrates a Hard Disk Drive (HDD) 101 and FIG. 1B illustrates a Solid State Drive (SSD) 151 with an intelligent printed circuit board assembly (PCBA). The HDD 101 in FIG. 1A comprises a printed circuit board assembly (PCBA) 102 in electrical communication with an actuator assembly 104 and an axial motor 106 in the HDD 101. Similarly, the SSD 151 in FIG. 1B comprises an intelligent PCBA 152 in electrical communication with the Non-Volatile Memory (NVM) 154 of the SSD 151. The intelligent PCBA 102, 152, controls the operations of the components 104, 106, 108, 154, within the HDD 101 and SSD 151. Further elaboration on this aspect will be provided in the description below.

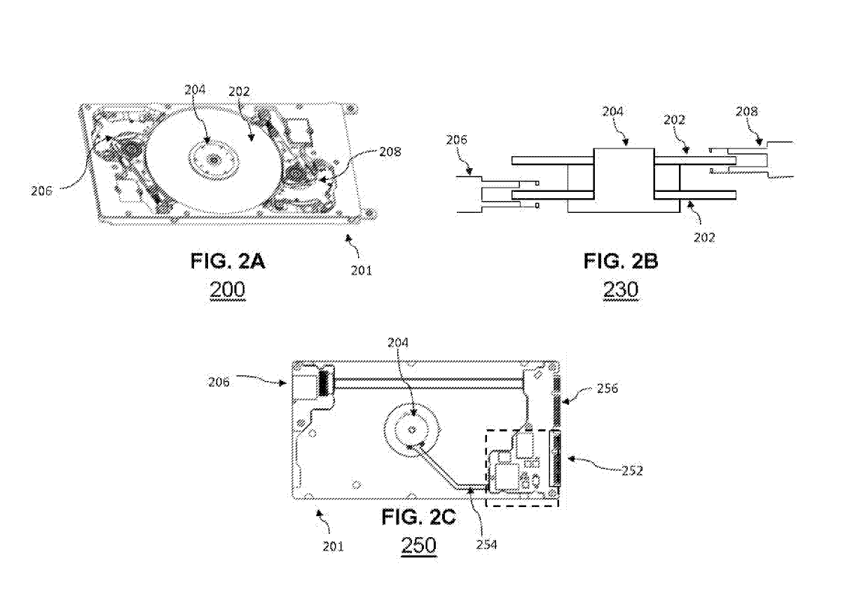

FIG. 2, comprising FIG. 2A, FIG. 2B, and FIG. 2C, illustrates components of a dual actuator HDD 201, wherein FIG. 2A illustrates a top cutaway perspective view 200 of the dual actuator HDD 201, FIG. 2B illustrates a side cross-sectional perspective view 230 of disk media 202 and dual actuators 206, 208 within the dual actuator HDD 201, and FIG. 2C illustrates a bottom cutaway perspective view 250 of the dual actuator HDD 201, in accordance with the present embodiment.

In FIG. 2A, the HDD 201 for data storage comprises one or more disk platters 202. Each of the one or more disk platters 202 has magnetic disk media on one or both sides, where the read/write heads of the actuators 206, 208 are positioned to read/write data onto the magnetic disk media. In an embodiment, the positioning of the dual actuators 260, 280 are 180 degrees from each other, as seen in FIG. 2B. Variations of the position of the dual actuators 260, 280 are also possible. An axial motor 204 provides rotation for the one or more disk platters 202 during operation.

FIG. 2C shows an external communication interface 256 coupled to an actuator assembly 206. In an alternative embodiment, more than one external communication interfaces 256 are present in the HDD 201, wherein each of the external communication interfaces 256 are coupled to a corresponding actuator 206, 208. Multi interface, multi actuator hard disk drives provide an advantageous means to increase data throughput to and from the storage device 201. The intelligent PCBA 252 is coupled 254 to the axial motor 204, the one or more actuators 206, 208, and the one or more interfaces 256. The arrangement in the present embodiment provides an advantageous connection between the intelligent PCBA 252 with the actuators 206, 208, the axial motor 204, and the external connection interfaces 256 enabling the intelligent PCBA 252 control over the components 202, 204, 206, 208, 256 within the HDD 201. The person skilled in the art of storage devices would understand that in various embodiments, components within a hybrid drive or SSD are connected in a similar manner as the present embodiment.

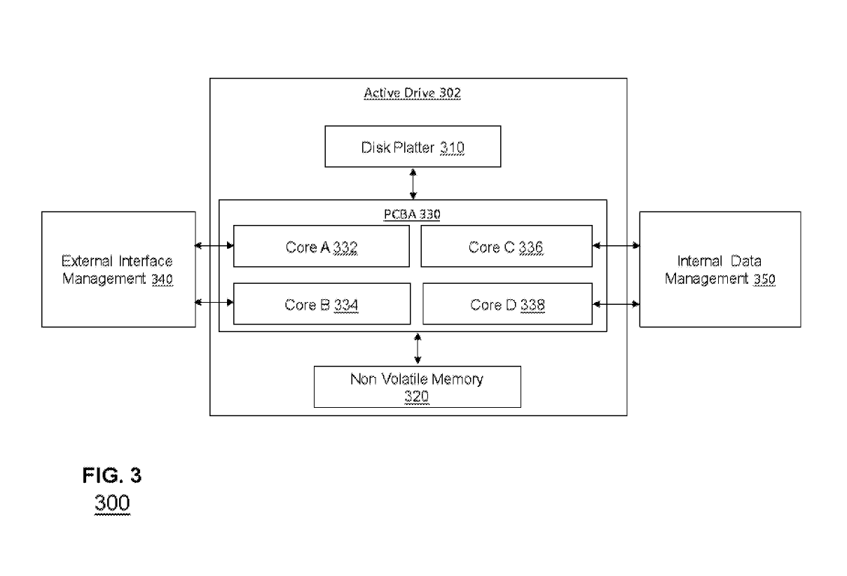

FIG. 3 depicts a block diagram 300 of a storage device, hereinafter Active Drive (AD) 302, comprising one or more disk platters 310, an NVM 320, and an intelligent PCBA 330 in accordance with the present embodiment. The intelligent PCBA 330 comprises a multi core processor with one or more cores 332, 334, 336, 338. The one or more cores 332, 334, 336, 338 are configured, to manage and perform various operations of the AD 302. In an embodiment, the first core 332 and the second core 334 are configured to perform external interface management 340, while the third core 336 and the fourth core 338 are configured to perform internal data management 350. In a further embodiment, third core 336 of the multi-core processor of the PCBA 330 cooperates with the fourth core 338 for the internal data management and file system management. The person skilled in the art of storage devices would understand that various other configurations are possible. For example, the cores 332, 334, 336, 338 of the processor are able to distribute external interface management 340 and internal data management 350 within each other, or redirect processing to any one or a combination of cores 332, 334, 336, 338.

The skilled person would further understand that in alternative embodiments, the AD 302 is a HDD, SSD or Hybrid drive with an intelligent PCBA 330. In an embodiment, an AD 302 comprising a hybrid drive with an intelligent PCBA 330 utilizes both magnetic disk media on the disk platter 310 and NVM 320 for hybrid data storage. Any one or a combination of cores 332, 334, 336, 338 of the multi-core processor of the PCBA 302 is devoted to servo management to control the movement of the actuators or axial motors within the HDD. Devoting one or more cores to external interface management 340, internal data management 350, and/or servo management advantageously provides an efficient means of resource allocation by eliminating the dependency on disk array controllers to perform the operations. Additionally, as each of the ADs 302 is able to perform interface management 340, internal data management 350, and servo management independently, this advantageously allows for a scalable network of ADs 302 to be connected together.

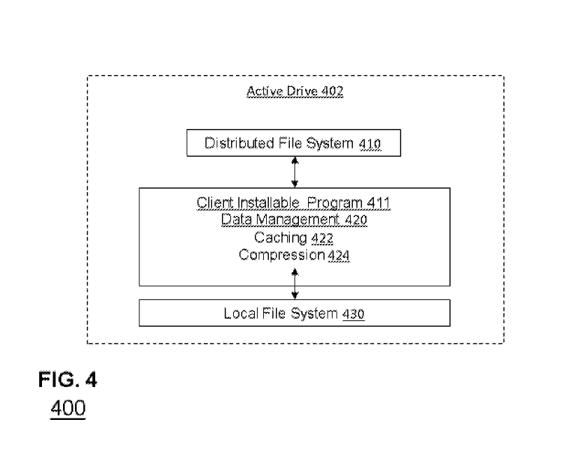

FIG. 4 depicts a diagram 400 illustrating functions of an AD 402 in accordance with the present embodiment. In the present embodiment, the AD 402 performs data management operations related to a distributed file system 410, such as restriction of access to the local file system 430 of the AD 402 depending on access lists, or listing directories within the AD 402. In the present embodiment, the AD 402 performs data management operations 420, such as caching of data 422 and compression of data 424 are performed, in accordance with instructions or predetermined protocols of the distributed file system 410 or automatically. The AD 402 can also have client installable program 411 to be installed and executed. Further, the AD 402 performs local file system 430 operations such as file space allocation and management of file names. The processing of the various operations 410, 420, 422, 424, and 430 are performed by any one or more of the cores of the multi-core processor of the PCBA within the AD 402. This advantageously allows the AD 402 to operate as an independent drive without relying on a disk array controller or storage server (i.e. server computer).

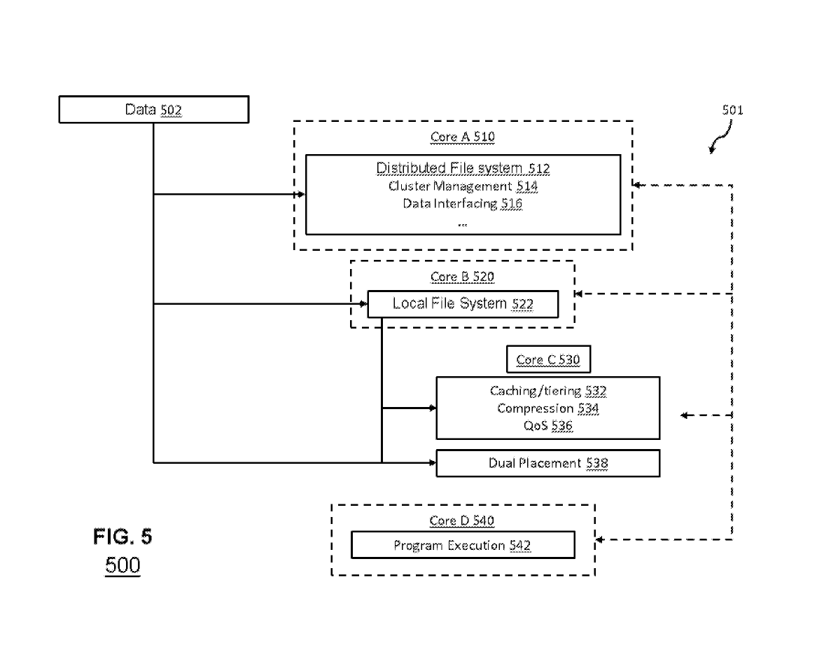

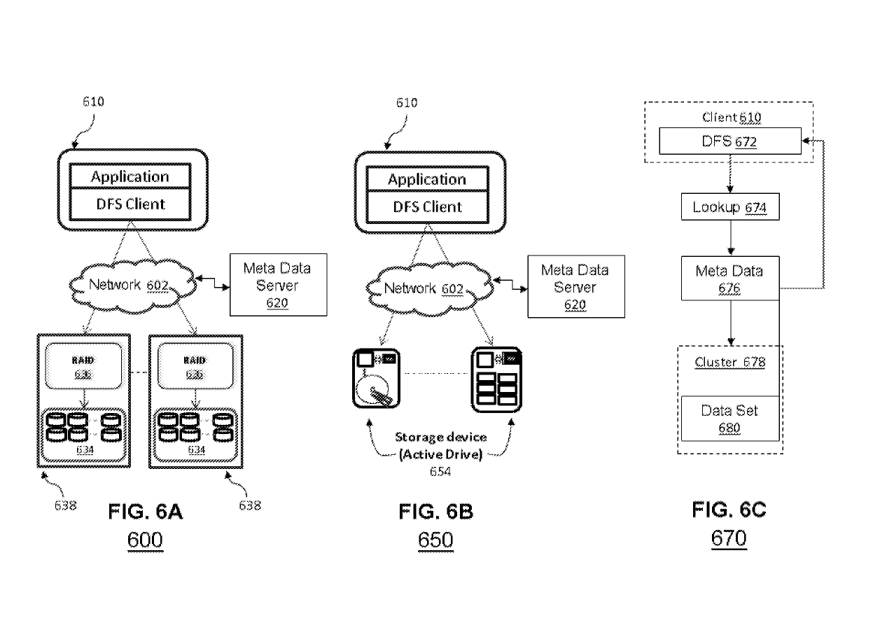

FIG. 5 depicts a diagram 500 illustrating functions 512, 514, 516, 522, 532, 534, 536, 538, 542, performed by one or more cores 510, 520, 530, 540 of the intelligent PCBA within an AD in accordance with the present embodiment. Various operations are allocated to the cores 510, 520, 530, 540 of the intelligent PCBA. For example, a first core 510 is devoted to managing operations related to the distributed file system 512, including cluster management 514, and data interfacing 516 to the client that is providing the data 502. A second core is devoted to managing operations involving the local file system 522. A third core is devoted to internal data management operations such as caching and tiering of data 532, compression of data 534, managing Quality of Service (QoS) operations such as error rates, bandwidth, throughput, transmission, delay, availability, and jitter, and placement of data within the disk media or NVM of the AD. A fourth core is devoted to program execution 542 of applications installed on the disk media or NVM of the AD. The program can be run time uploaded and installed into AD 402 by client terminal. With the intelligent PCBA of an AD performing the functions 512, 514, 516, 522, 532, 534, 536, 538, 542, disk array controllers are advantageously eliminated as data can be directly transferred to the AD. For example, tasks such as storage management are now performed by one or more cores of the multi core processor of the intelligent PCBA of the AD. This advantageously provides a highly scalable and cost effective means to construct an AD distributed file system, wherein a plurality of ADs are independently in communication with the client via a network. This network of drives advantageously allows for a reduction in cost, power consumption, and physical space required. Furthermore, a dedicated core of the multi core processor devoted to critical operations (e.g. Quality of service operations), advantageously allows an increased reliability of the ADs as compared to conventional drives.

FIG. 6, comprising FIG. 6A, FIG. 6B, and FIG. 6C, depict a diagram of a system 600, 650 of one or more storage devices 634, 654 in a network 602, wherein FIG. 6A depicts a system 600 of one or more conventional storage devices 634 in communication with a client 610 and a metadata server 620 through a network 602, FIG. 6B depicts a system 650 with one or more storage devices (i.e. ADs) 654, in accordance with the present embodiment, in communication with a client 610 and a metadata server 620 through a network 602, and FIG. 6C depicts an exemplary operation 670 performed in the system 650 in accordance with the present embodiment.

In the system 600, a plurality of conventional storage devices 634 are connected to a network 602 via a disk array controller (e.g. RAID controller) 636. The plurality of storage devices 634 are presented to the client 610 as a storage unit 638. Each of the storage units 638 requires a storage server for data interface and management in each of the storage units 638. This results in an inefficient architecture for scaling.

The system 650, provides an advantageous alternative to the conventional distributed storage system. In the system 650, the storage devices 654 within the network 602 are ADs, each comprising an intelligent PCBA in accordance with the preceding embodiments. The intelligent PCBA comprises an NVM and a multi-core processor, wherein a first core of the multi-core processor is devoted to external interface management and a second core of the multi-core processor is devoted to internal data management of the corresponding one of the one or more storage devices 654. The one or more storage devices 654 and the one or more client terminals 610 are coupled network 602 and configured to perform data storage operations within the one or more storage devices 654 in response to a request by any one of the one or more client terminals 610. In the present embodiment, the distributed data storage operation is performed in cooperation with the first core's external interface management. Distributed data storage operations and/or external interface management within the storage device 654 itself eliminates the dependency on a disk controller 636 or storage server for managing these operations. Dedicating one or more cores to each of these operations allows for a distributed workload, and therefore an advantageous improvement in efficiency and throughput of the storage devices 654 within the network 602.

In an embodiment, the first core of the multi-core processor of the PCBA of each of the one or more storage devices 654 is configured to perform data interfacing to the client terminal 610. In conventional servers, disk array controllers perform the task of data interfacing with the client terminal 610. Enabling the storage devices 604 to perform data interfacing operations advantageously allows parallel data access between individual storage devices 654 and the client terminals 610.

In the present embodiment, the multi-core processor of the PCBA of each of the one or more storage devices 654 is configured to perform autonomous data clustering in response to a request by any one of the one or more client terminals 610. In a data clustering operation, the intelligent PCBA allocates contiguous groups of sectors, i.e. clusters, within the disk media of the storage device 654. Clustering reduces the overhead of managing on-disk data structures, and when performed independently by the intelligent PCBA, advantageously allows for an increased efficiency of the clustering operation.

The multi-core processor of the PCBA of each of the one or more storage devices 654 is also configured to execute a program stored on any one or more storage devices 654 in response to a request by any one or more client terminals 610. Users are able to access the application installed on any one of the storage devices 654 though the client terminals 610. One or more cores of the multi-core processor of the intelligent PCBA may be devoted to the running of the application during the period of the request. This advantageously provides a means for the users to gain access to software applications and processes via the network 602 remotely. Further, processing of the application is performed by the intelligent PCBA of the storage device 654, which advantageously reduces the dependency of the Central Processing Unit (CPU) of the server for running of applications.

As in previous embodiments, cores of the multi-core processors of the PCBA of each of the storage devices 654 a devoted to servo management. Another core of the multi-core processor cooperates with the second core for the internal data management and file system management. Further, another core of the multi-core processor is devoted to caching and tiering. Dedicating one or more cores to each of these operations allows for a distributed workload, and therefore an advantageous improvement in efficiency and throughput of the storage devices 654 within the network 602.

In an embodiment, the system 650 further comprises a metadata server 620 coupled to the network 602. In FIG. 6C, an exemplary operation of the system 650 of storage devices 654 is depicted. A client 610, performs a request to retrieve data from a storage device 654 within the system 650. The request is received in the distributed file system 672 of the client and processed against a lookup table 674 to retrieve the meta data 676 stored in the meta data server 620. Using the meta data 676, comprising information of where the data is stored, the distributed file server accesses the cluster 678 at which the storage device 654, or plurality of storage devices 654, stores the data 680. The data set 680 is retrieved for further processing by an application on the client's terminal 610. In an alternative embodiment, the client 610 may instruct an application installed on the storage device 654 within the cluster 678 to access the data set 680 to and perform operations on the data set 680. In an alternative embodiment, the client only gets the map of storage cluster which consisting of multiple AD 654 from meta data server, and then computes the data location by its self, and then retrieve the data directly from the AD 654. In the present embodiment, communication between the storage device 654 and the client terminal 610 is devoted to one core of the multi-core processor of the PCBA within the storage device 654. In a further embodiment, another core of the multi-core processor is dedicated to running of the application and performing operations on the data set 680.

The skilled person would understand that in alternative embodiments, the storage device 654 comprises any one or more of Active Drives, including multi actuator multi disk HDDs, SSDs, and Hybrid disks having NVM that is used with disk media of the HDD for hybrid data storage.

Thus, in accordance with the present embodiment, a novel, advantageous and efficient method for PCBA implementation has been presented, which overcomes the drawback of prior art.

While exemplary embodiments have been presented in the foregoing detailed description of the invention, it should be appreciated that a vast number of variations exist. For example, those skilled in the art will realize from the teachings herein that the present technology may also be applied to any PCBA.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. A printed circuit board assembly (PCBA) for a storage device comprising:
a non-volatile memory (NVM); and
a multi-core processor,
wherein a first core of the multi-core processor is coupled to one or more devices external to the PCBA and the storage device, and wherein the first core is configured for external interface management of the one or more devices external to the PCBA and the storage device including one or more of distributed file system management and management of a multi-device storage cluster, and wherein a second core of the multi-core processor is configured for internal data management of the storage device and/or the NVM.

2. The PCBA in accordance with claim 1, wherein another core of the multi-core processor is configured for one or more of servo management and/or caching and tiering.

3. The PCBA in accordance with claim 1, wherein another core of the multi-core processor cooperates with the second core for the internal data management and file system management.

4. A Hard Disk Drive (HDD) comprising:
disk media; and
a printed circuit board assembly (PCBA) coupled to the disk media for external interface management and internal data management, the PCBA comprising:
a non-volatile memory (NVM); and
a multi-core processor,
wherein a first core of the multi-core processor is coupled to one or more devices external to the HDD including one or more storage devices external to the HDD, and wherein the first core is configured for the external interface management of communication with the one or more devices external to the HDD including one or more of distributed file system management on at least a portion of the one or more storage devices external to the HDD and management of a multi-device cluster including storage on at least a portion of the one or more storage devices external to the HDD, and
wherein the NVM is used with the disk media of the HDD for hybrid data storage, and
wherein a second core of the multi-core processor is configured for the internal data management of the NVM and the HDD.

5. The HDD of claim 4 wherein the disk media comprises multiple disk platters, the HDD further comprising multiple actuators for reading data from and writing data to the multiple disk platters, wherein the second core of the multi-core processor of the PCBA is coupled to the multiple disk platters and the multiple actuators for internal data management.

6. A Solid State Drive (SSD) comprising a printed circuit board assembly (PCBA), the PCBA comprising:
a non-volatile memory (NVM); and
a multi-core processor, wherein a first core of the multi-core processor is coupled to one or more devices external to the SSD including one or more storage devices external to the SSD, and wherein the first core is configured for external interface management of the one or more devices external to the SSD including one or more of distributed file system management on at least a portion of the one or more storage devices external to the SSD and management of a multi-device cluster including storage on at least a portion of the one or more storage devices external to the SSD and a second core of the multi-core processor is configured for internal data management of the SSD.

7. A hard disk drive (HDD) for data storage comprising:
one or more disk platters, each of the one or more disk platters having magnetic disk media on one or both sides;
an axial motor for rotating the one or more disk platters;
one or more actuators for reading data to and writing data from the one or more disk platters;
one or more interfaces coupled to the one or more actuators; and
a printed circuit board assembly (PCBA) coupled to the axial motor, the one or more actuators, and the one or more interfaces, wherein the PCBA comprises:
a non-volatile memory (NVM); and
a multi-core processor, wherein a first core of the multi-core processor is coupled to one or more devices external to the HDD including one or more storage devices external to the HDD, and wherein the first core is configured for external interface management of the one or more devices external to the HDD including one or more of distributed file system management on at least a portion of the one or more storage devices external to the HDD and management of a multi-device cluster including storage on at least a portion of the one or more storage devices external to the HDD and a second core of the multi-core processor is coupled to the NVM and/or the one or more interfaces and is configured for internal data management of the NVM and/or the magnetic disk media.

8. The HDD for data storage in accordance with claim 7, wherein another core of the multi-core processor of the PCBA is configured for one or more of servo management and/or caching and tiering.

9. The HDD for data storage in accordance with claim 7, wherein another core of the multi-core processor of the PCBA cooperates with the second core for the internal data management and file system management of the NVM and/or the magnetic disk media.

10. The HDD for data storage in accordance with claim 7, wherein the NVM is used with the magnetic disk media for hybrid data storage, and wherein the second core of the multi-core processor is configured for internal data management of both the NVM and the magnetic disk media.

11. A system for distributed data storage, the system comprising:
a plurality of storage devices, each of the plurality of storage devices comprising a printed circuit board assembly (PCBA), the PCBA comprising:
a non-volatile memory (NVM); and
a multi-core processor, wherein a first core of the multi-core processor is configured for external interface management and a second core of the multi-core processor is configured for internal data management of the corresponding one of the plurality of storage devices;
a network; and
one or more client terminals, wherein the plurality of storage devices and the one or more client terminals are coupled to the network, and wherein the multi-core processor of the PCBA of one or more of the plurality of storage devices are further configured to perform distributed data storage operations within the one or more of the plurality of storage devices in response to a request by any one of the one or more client terminals, the distributed data storage operations performed in cooperation with the first core's external interface management.

12. The system for distributed data storage in accordance with claim 11, wherein the network further comprises one or more metadata servers coupled to the network, the multi-core processor of the PCBA of the one or more of the plurality of storage devices performing the distributed data storage operations within the one or more of the plurality of storage devices in cooperation with at least one of the one or more metadata servers.

13. The system for distributed data storage in accordance with claim 11, wherein the multi-core processor of the PCBA of each of the one or more storage devices is further configured to perform autonomous data clustering in response to a request by any one of the one or more client terminals.

14. The system for distributed data storage in accordance with claim 11, wherein the multi-core processor of the PCBA of each of the one or more storage devices is further configured to execute a program on any of the one or more storage devices the first core's external interface management in response to a request by any of the one or more client terminals.

15. The system for distributed data storage in accordance with claim 11, wherein the first core's external interface management is further configured to perform data interfacing to the one or more client terminals.

16. The system for distributed data storage in accordance with claim 11, wherein the multi-core processor of at least one of the plurality of storage devices is further configured for one or more of servo management and/or caching and tiering.

17. The system for distributed data storage in accordance with claim 11, wherein the multi-core processor of at least one of the plurality of storage devices cooperates with the second core of the multi-core processor of the at least one of the plurality of storage devices for the internal data management and for file system management.

18. The system for distributed data storage in accordance with claim 11, wherein at least one of the plurality of storage devices further comprises a hard disk drive (HDD), and wherein the HDD is selected from the group comprising a single actuator, single disk HDD, a multi actuator, single disk HDD and a multi actuator, multi disk HDD.

19. The system for distributed data storage in accordance with claim 18, wherein the NVM of each of the plurality of storage devices is used with disk media of the HDD for hybrid data storage.

20. The system for distributed data storage in accordance with claim 11, wherein at least one of the plurality of storage devices comprises a solid state device (SSD).
